(19) United States
(12) Patent Application Publication
(10) Pub. No.: US 2006/0127583 A1
(43) Pub. Date: Jun. 15, 2006

(54) Polyhedral oligomeric silsesquioxanes and polyhedral oligomeric silicates barrier materials for packaging

(76) Inventors: Joseph D. Lichtenhan, Petal, MS (US); Rene I. Gonzalez, San Juan, PR (US); Jose I. Gonzalez, Guaynabo, PR (US)

Correspondence Address: PILLSBURY WINTHROP SHAW PITTMAN LLP, P.O. BOX 10500, MCLEAN, VA, 22102, US

(21) Appl. No.: 11/297,041

(22) Filed: Dec. 7, 2005

Related U.S. Application Data
(63) Continuation-in-part of application No. 11/015,185, filed on Dec. 17, 2004.
(60) Provisional application No. 60/634,495, filed on Dec. 8, 2004.
(60) Provisional application No. 60/531,458, filed on Dec. 18, 2003.

(51) Int. Cl. B05D 3/00; C08L 83/00; B32B 27/28

(52) U.S. Cl. 427/331; 525/474; 528/14

(57) ABSTRACT

A method for barrier property enhancement using silicon containing agents and in situ formation of nanoscopic glass layers on polymer surfaces. Nanostructured chemicals such as polyhedral oligomeric silsesquioxane (POSS) are added to polymers, followed by in situ surface oxidation to form a glass layer.

### CROSS-REFERENCE TO RELATED APPLICATIONS

This application and claims the benefit of U.S. Provisional Patent Application Ser. No. 60/634,495 filed Dec. 8, 2004; is a continuation-in-part of U.S. patent application Ser. No. 11/015,185 filed Dec. 17, 2004, which claims the benefit of U.S. Provisional Patent Application Ser. No. 60/531,458 filed Dec. 18, 2003.

### FIELD OF THE INVENTION

This invention relates generally to methods for enhancing the barrier properties of polyethylene, polypropylene, polyamide, polyester terephthalate and natural polymers such as cellulose and polylactic acid polymers. More particularly, it relates to the incorporation of nanostructured chemicals such as polyhedral oligomeric silsesquioxane (POSS) and polyhedral oligomeric silicates (POS) for gas and moisture barrier control in multilayered polymer laminate packaging or bottles for foods, beverages, pharmaceuticals, and medicines.

The applications for such materials include replacement of metallized polymer packaging, replacement of metal cans, and replacement of packaging that contains discreet adhesive layers and a discreet silica layer.

### BACKGROUND OF THE INVENTION

The invention is related to use of polyhedral oligomeric silsesquioxane, silsesquioxane, polyhedral oligomeric silicate, silicates, silicones or metallized-polyhedral oligomeric silsesquioxane, silsesquioxane, polyhedral oligomeric silicate, silicates, silicones as alloyable agents in polypropylene (PP), polyamide (PA), polyestererephthalate (PET). Note that polyhedral oligomeric silsesquioxane, silsesquioxane, polyhedral oligomeric silicate, silicates, silicones or metallized-polyhedral oligomeric silsesquioxane, silsesquioxane, polyhedral oligomeric silicate, silicates, silicones are hereafter referred to as “silicon containing agents.” Silicon containing agents have previously been utilized to complex metal atom(s) as reported in U.S. Pat. No. 6,441,210. As discussed in U.S. Pat. No. 6,716,919, and WO 01/72885 PCT/US01/09668, such silicon containing agents are useful for the dispersion and alloying of silicon and metal atoms with polymer chains uniformly at the nanoscopic level. Silicon containing agents can be converted in the presence of atomic oxygen to form a glass like silica layer. The use of such silicon containing agents to form oxidation protective glass layers was discussed in U.S. Pat. No. 6,767,930. The use of such silicon containing agents to form fire protective surface char coatings has been described in U.S. Pat. No. 6,362,279. Silicon containing were also described to be useful in the formation of permeable porous membranes as discussed in U.S. Pat. No. 6,425,936.

In light of the above it has been surprisingly discovered that such silicon containing agents are also useful for the formation of gas and liquid barriers in multilayered thin film packaging products. In such capacity the silicon containing agents are themselves effective when alloyed into a polymer but especially effective for the in situ formation of nanoscopically thin glass barriers upon their exposure to oxygen plasma, ozone, an oxidizing flame, or a hot oxidizing gas such as air.

Advantages of the use of silicon containing agents include their ability to reduce or plug free volume in polymers, thus reducing permeability, or when converted into a nanoscopically thin glass layer the permeability is reduced by the impermeability of the layer. Other advantages include: the nondetectable nature of the nanoscopic barrier by the human eye, toughness and flexibility and thereby suitability for storage on rolls and thin film packaging, radiation absorption, impermeability to liquids and gas, direct printability, stain resistance, environmental degradation resistance, chemical degradation resistance, scratch resistance, lower cost and lighter weight than glass, excellent adhesion between polymer and glass due to elimination of discreet compositional bondlines and replacement of them by compositionally graded material interfaces, improved mechanical properties (such as heat distortion, creep, compression set, shrinkage, modulus, hardness, and abrasion resistance), and improved physical properties (such as electrical and thermal conductivity and fire resistance). Superior adhesive qualities are also a realizable advantage, as nanoscopic silicon agents have been used in dental adhesive. Finally, silicon agents containing metals can provide stabilization to the polymers through absorption of photon and particle radiation that could otherwise damage the polymer and accelerate its degradation. All of these factors contribute to a packaging material with superior barrier and transparency properties over those achieved using prior art methods.

A number of prior art methods are known to produce packaging with low barrier properties to gases and moisture. Such methods include the deposition of metals and thin glass coatings on polymers as described in U.S. Pat. No. 6,720,097. While effective, this approach is not amenable to a wide range of high speed molding and extrusion processing. This method also suffers from poor interfacial bonding between the glass or metal and polymer layers. A popular prior art approach has also involved the incorporation of two dimensional platelet materials such as clays, micas, talcs, glass flakes, carbon mesophases and tubes (U.S. Pat. Nos. 6,376,591 and 6,387,996). This prior art is deficient in the ability to incorporate sufficiently high uniformities of the additive to provide both a high barrier while retaining optical transparency. Therefore, a compromise in barrier level is accepted in order to accommodate transparency and decorative appearance. A further limitation of the latter approach has been the use of naturally derived fatty surfactants such as tallows in order to render the two dimensional platelet material compatible with the polymer layer. While this approach is cost effective it introduces the potential for biologically active contaminants into the packaging material that may render it unsuitable for food and sterile medical products.

The silicon containing agents of most utility in this work are best exemplified by those based on low cost silicon compounds such as silsesquioxanes, polyhedral oligomeric silsesquioxanes, and polyhedral oligomeric silicates. FIG. 1 illustrates some representative examples of silicon compounds containing siloxane, silsesquioxane, and silicate examples. The R groups in such structures can range from H, to alkane, alkene, alkyne, aromatic and substituted organic systems including ethers, acids, amines, thiols, phosphates, and halogenated R groups. The structures and compositions are also intended to include metallized derivatives where metals ranging from high to low Z can be incorporated into the structures.

The silicon containing agents all share a common hybrid (i.e., organic-inorganic) composition in which the internal framework is primarily comprised of inorganic silicon-oxygen bonds. The incorporation of such agents provides a barrier to moisture and oxygen though the blockage of amorphous regions and free volume contain in the solid state structure of the polymers. Barrier properties can be improved further via mild in situ oxidation of the nanoscopic silicon entities into nanoscopically thin silica glasses. The glassification process may be carried out during film processing or after processing. The exterior of a nanostructure is covered by both reactive and nonreactive organic functionalities (R), which ensure compatibility and tailorability of the nanostructure with organic polymers. These and other properties of nanostructured chemicals are discussed in detail in U.S. Pat. Nos. 5,412,053 and U.S. Pat. No. 5,484,867, both of which are expressly incorporated herein by reference in their entirety. These nanostructured chemicals are of low density, and can range in diameter from 0.5 nm to 5.0 nm.

### SUMMARY OF THE INVENTION

The present invention describes a new series of polymer additives and their utility in the formation of gas and moisture barriers in polymers and on polymer surfaces. The resulting nano-alloyed polymers are wholly useful by themselves, in combination with other polymers, or in combination with macroscopic reinforcements such as fiber, clay, glass, metal, mineral, and other particulate fillers, inks, and pigments. The nano-alloyed polymers are particularly useful for producing multilayered packaging with enhanced oxygen and moisture barrier properties, printability, stain, acid and base resistance. The preferred compositions presented herein contain two primary material combinations: (1) silicon containing agents including nanostructured chemicals, nanostructured oligomers, or nanostructured polymers from the chemical classes of silicones, polyhedral oligomeric silsesquioxanes, polysilsesquioxanes, polyhedral oligomeric silicates, polysilicates, polyoxometallates, carboranes, boranes; and (2) manmade thermoplastic polymers such as polypropylene, polyamides, and polyesters.

A preferred method of incorporating nanostructured chemicals into thermoplastics is accomplished via melt mixing of the silicon containing agents into the polymers. All types and techniques of blending, including melt blending, dry blending, solution blending, reactive and nonreactive blending are also effective.

In addition, the selective incorporation and maximum loading levels of a silicon containing agent into a specific polymer can be accomplished though use of a silicon containing agent with a chemical potential (miscibility) compatible with the chemical potential of the region within the polymer in which it is to be alloyed. Because of their chemical nature, silicon containing agents can be tailored to show compatibility or incompatibility with selected sequences and segments within polymer chains and coils. Their physical size in combination with their tailorable compatibility enables silicon containing agents based on nanostructured chemicals to be selectively incorporated into polymers and to control the dynamics of coils, blocks, domains, and segments, and subsequently favorably impact a multitude of physical properties.

A specific benefit of incorporation of nanoscopic silicon containing agents as barrier materials is their use at low loadings to plug accessible free volume within the polymer. Permeation (P) is controlled by the equation P=DS where D is the diffusion coefficient and S is the solubility of a component in a material. For barrier applications, nanoscopic silicon agents can displace gas molecules within a polymer and thereby decrease the solubility of a gas within a polymer. Further, they can also occupy the accessible volume available for diffusion of gases and thereby reduce the overall permeability.

The process of forming in situ glass glazings on articles molded from polymers alloyed with silicon containing agents is carried out by exposure of the articles to oxygen plasma, ozone, or other highly oxidizing mediums. These chemical oxidation methods are desirable as they are current industrial processes and they do not result in heating of the polymer surface. There are no topological constraints, or decorative restrictions on the molded articles. Post processing, the parts contain nanometer thick surface glass layers. The most efficient and thereby preferred oxidation method is oxygen plasma. However for alloys where the R on the silicon containing agent is H, methyl or vinyl, they can be converted to glass upon exposure to ozone, peroxide, or even hot steam. A reliable alternate to the above methods is the use of an oxidizing flame. The choice of method is dependent upon the chemical agent—polymer alloy system, loading level of the silicon containing chemical agent, surface segregation of agent, the thickness of the silica surface desired and manufacturing considerations. A picture of the nanoscopic level dispersion of silicon containing agent in a polymer is shown in FIG. 2.

Upon exposure of the surface to the oxidation source, a nanoscopically thin layer of glass from 1-500 nm will result, and preferably from 1-100 nm, depending upon the oxidation conditions used. The thickness of the layer formed may vary with the required properties of the glass layer (e q impermeability, scratch resistance, transparency, radiation attenuation, etc.) If the silica containing agent contained a metal, then the metal will also be incorporated into the glass layer. Advantages derived from the formation of a nanoscopic glass surface layer include barrier properties for gases and liquids, improved chemical and oxidative stability, flammability reduction, improved electrical properties, improved printability, improved stain and scratch resistance. Furthermore the nanoscopically thin layer of silica is seamlessly integrated with the bulk virgin polymer and is both ductile and capable of being stored on rolls and laminated into multilayer packages.

### BRIEF DESCRIPTION OF THE DRAWINGS

FIG. 1 shows representative structural examples of nonmetallized silicon containing agents.

FIG. 2 illustrates the ability to uniformly disperse nanostructured silicon agents at the 1-3 nm level at the surface and the bulk of a polymer.

FIG. 3 illustrates the ability of metallized silicon agents to selectively absorb damaging radiation.

FIG. 4 illustrates the chemical process of oxidative conversion of a silicon containing agent into a fused nanoscopically thin glass layer.

FIGS. 5(A) to 5(F) illustrate preferred methods of incorporating nanostructured silicon containing agents into plastic multilaminate packaging.

### DEFINITION OF FORMULA REPRESENTATIONS FOR NANOSTRUCTURES

For the purposes of understanding this invention's chemical compositions the following definition for formula representations of silicon containing agents and in particular Polyhedral Oligomeric Silsesquioxane (POSS) and Polyhedral Oligomeric Silicate (POS) nanostructures is made.

Polysilsesquioxanes are materials represented by the formula [RSiO_{1.5}]_{∝} where ∝ represents molar degree of polymerization and R=represents an organic substituent (H, siloxy, cyclic or linear aliphatic, or aromatic groups that may additionally contain reactive functionalities such as alcohols, esters, amines, ketones, olefins, ethers or which may contain halogens). Polysilsesquioxanes may be either homoleptic or heteroleptic. Homoleptic systems contain only one type of R group while heteroleptic systems contain more than one type of R group.

POSS and POS nanostructure compositions are represented by the formula:

[(RSiO_{1.5})ₙ]_{Σ#} for homoleptic compositions

[(RSiO_{1.5})ₙ(R′SiO_{1.5})ₘ]_{Σ#} for heteroleptic compositions (where R≢R′)

[(RSiO_{1.5})ₙ(RSiO_{1.0})ₘ(M)ⱼ]_{Σ#} for heterofunctionalized heteroleptic compositions

[(RSiO_{1.5})ₙ(RXSiO_{1.0})ₘ]_{Σ#} for functionalized heteroleptic compositions (where R groups can be equivalent or not equivalent)

In all of the above R is the same as defined above and X includes but is not limited to OH, Cl, Br, I, alkoxide (OR), acetate (OOCR), peroxide (OOR), amine (NR₂) isocyanate (NCO), and R. The symbol M refers to metallic elements within the composition that include high and low Z metals and in particular Al, B, Ce, Ni, Ag, Ti. The symbols m, n and j refer to the stoichiometry of the composition. The symbol Σ indicates that the composition forms a nanostructure and the symbol # refers to the number of silicon atoms contained within the nanostructure. The value for # is usually the sum of m+n, where n ranges typically from 1 to 24 and m ranges typically from 1 to 12. It should be noted that Σ# is not to be confused as a multiplier for determining stoichiometry, as it merely describes the overall nanostructural characteristics of the system (aka cage size).

### DETAILED DESCRIPTION OF THE INVENTION

The present invention teaches the use of silicon containing agents as alloying agents for the design and preparation of polymers and polymer laminate packages with barrier properties toward oxygen and water. It is recognized that additional barrier can be obtained through the in situ formation of glass layers on the polymeric materials through the in situ oxidation of the nanoscopic silicon containing agents.

The keys that enable silicon containing agents such as nanostructured chemicals to function in this capacity include: (1) their unique size with respect to polymer chain dimensions, and (2) their ability to be compatibilized and uniformly dispersed at the nanoscopic level with polymer systems to overcome repulsive forces that promote incompatibility and expulsion of the nanoreinforcing agent by the polymer chains, (3) the hybrid composition and its ability glassify upon exposure to selective oxidants, (4) the ability to chemically incorporate metals into the silica agent and into the corresponding glass rendered therefrom. The factors to effect selection of a silicon containing agent for permeability control and glassification include the nanosizes of nanostructured chemicals, distributions of nanosizes, and compatibilities and disparities between the nanostructured chemical and the polymer system, the loading level of the silica agent, the thickness of the silica layer desired, and the optical and physical properties of the polymer.

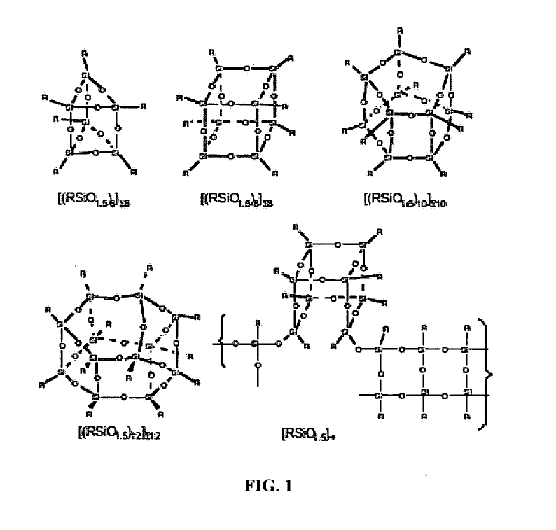

Silica agents, such as the polyhedral oligomeric silsesquioxanes illustrated in FIG. 1, are available as solids and oils and with or without metals. Both forms dissolve in molten polymers or in solvents, or can be reacted directly into polymers or can themselves be utilized as a binder material. For POSS, dispersion appears to be thermodynamically governed by the free energy of mixing equation (ΔG=ΔH−TΔS). The nature of the R group and ability of the reactive groups on the POSS cage to react or interact with polymers and surfaces greatly contributes to a favorable enthalpic (ΔH) term while the entropic term (ΔS) is highly favorable because of the monoscopic cage. size and distribution of 1.0.

The above thermodynamic forces driving dispersion are also contributed to by kinetic mixing forces such as occur during high shear mixing, solvent blending or alloying. The kinetic dispersion is also aided by the ability of some silica agents to melt at or near the processing temperatures of most polymers.

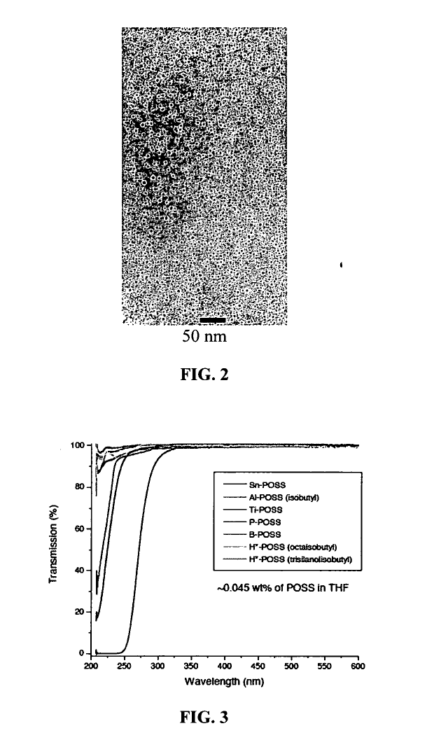

Therefore, by controlling the chemical and processing parameters, nanoreinforcement and the alloying of polymers at the 1.5 nm level can be achieved for virtually any polymer system as illustrated in FIG. 2. Silica containing agents can also be utilized in combination with macroscopic fillers to render similar desirable benefits relative to enhancements of physical properties, barrier, stain resistance, acid and base resistance, and radiation absorption. Thus the absorption of damaging radiation can be accommodated through metallized silica containing agents such as nickel, titanium, cerium, or boron (FIG. 3). Such metallized systems are of high value for stabilization of polymers against environmental degradation and degradation of contents such as vitamins, flavorants, colorant and other nutrients.

The present invention shows that barrier property enhancements can be realized by the direct blending of silicon containing agents, preferably nanostructured chemicals, directly into polymers. This greatly simplifies the prior art processes.

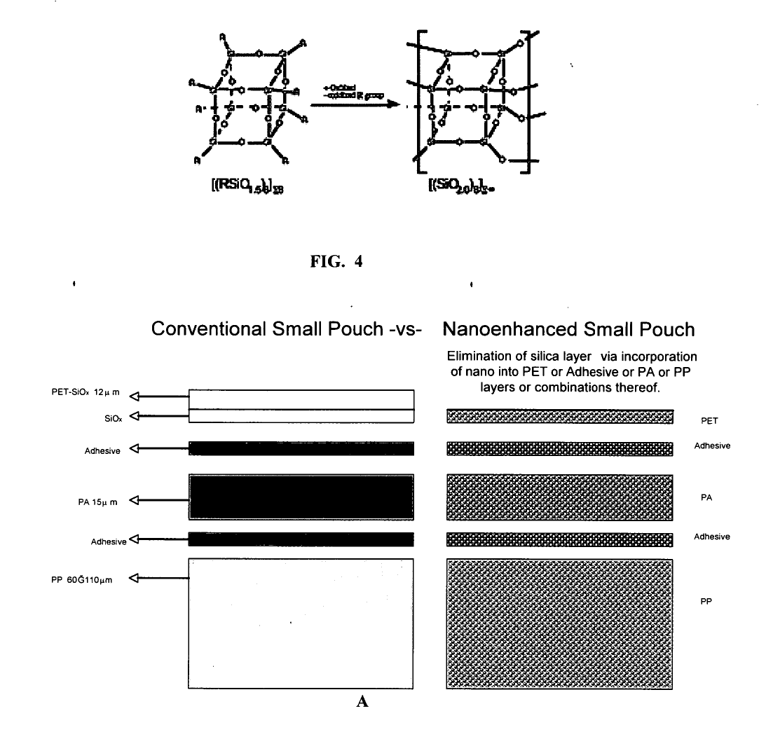

Furthermore, because silicon containing agents like nanostructured chemicals possess spherical shapes (per single crystal X-ray diffraction studies), like molecular spheres, and because they dissolve, they are also effective at reducing the viscosity of polymer systems. This benefits the processing, molding, or coating of articles using such nano-alloyed polymers, yet with the added benefits of reinforcement of the individual polymer chains due to the nanoscopic nature of the chemicals. Subsequent exposure of the nano-alloyed polymers to oxidizing agents results in the in situ formation of nanscopic glass on the exposed surfaces. FIG. 4 illustrates the oxidation of silicones such as silsesquioxanes to glass. Upon exposure of the nano-alloyed polymer to an oxidizing source the silicon-R bonds are broken and the R group is lost as a volatile reaction byproduct while the valency to the silicon is maintained through the fusing of cages together by bridging oxygen atoms, rendering the equivalent of fused glass. Thus, ease of in situ formation of this glass surface layer is obtainable through the use of nanostructured silicon containing agents. The prior art would have required the use a secondary coating or deposition method that would have resulted in formation of a micron thick layer of glass on the surface.

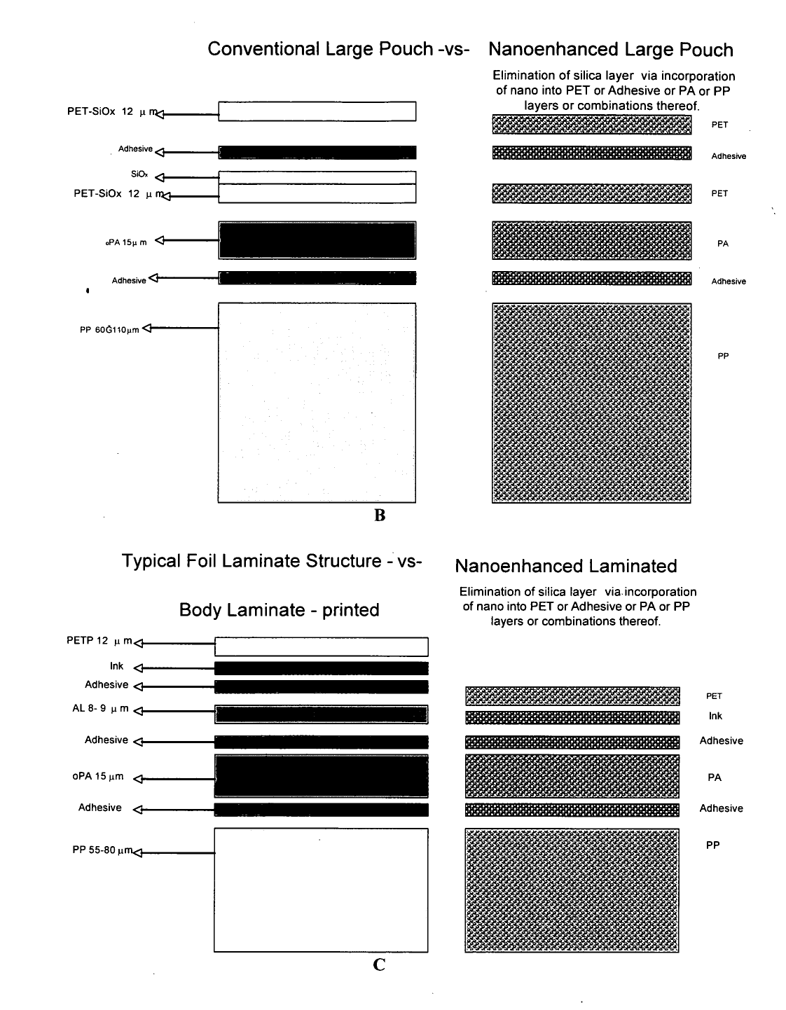

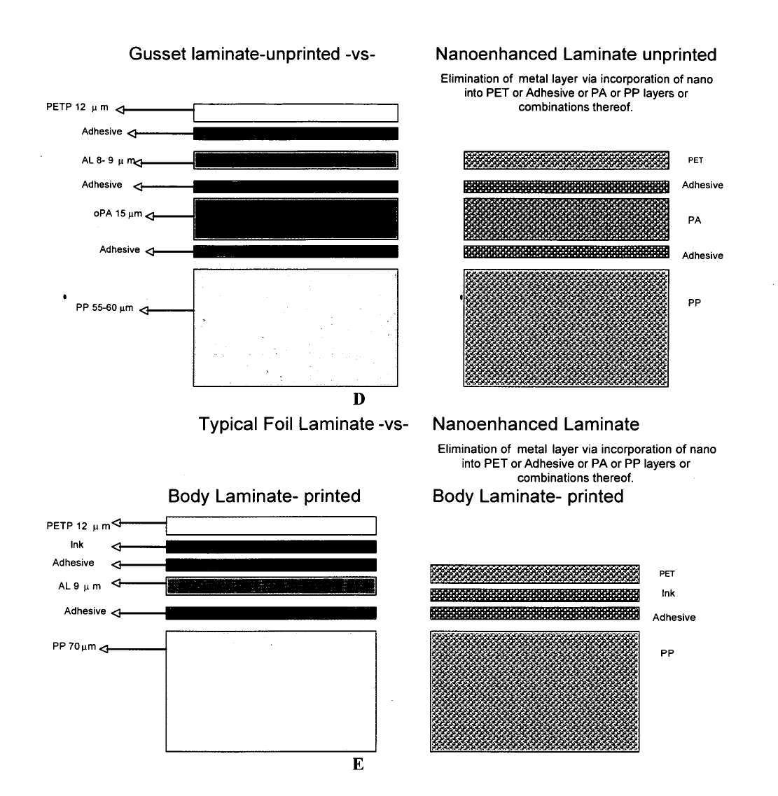

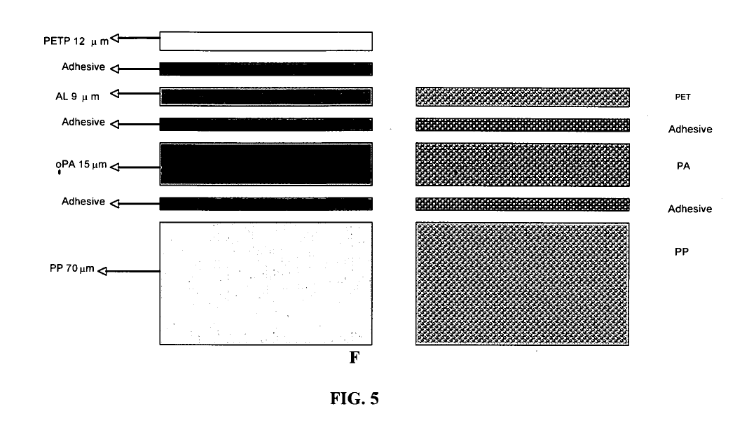

The nanoscopically dispersed nature of the silica containing agent within and throughout the polymer coupled with the ability to in-situ form glass layer directly in the polymer surface of molded articles affords a tremendous advantage in reducing processing cost due to time and material reductions and package simplification (FIG. 5). A wide variety of multilaminate polymer packaging architectures exists. Therefore, FIGS. 4-5A-F are intended to depict in a nonlimiting manner the incorporation of the invention into current packaging design. Loading levels of the silicon containing agent can range from 0.1%-99%, by weight with a preferred range from 1-30 wt %.

### EXAMPLES

General Process Variables Applicable To All Processes

As is typical with chemical processes there are a number of variables that can be used to control the purity, selectivity, rate and mechanism of any process. Variables influencing the process for the incorporation of silicon containing agents (e.g. silicones and silsesquioxanes) into plastics include the size, polydispersity, and composition of the nanoscopic agent. Similarly the molecular weight, polydispersity, and composition of the polymer system must also be matched between that of the silicon containing agent and polymer. Finally, the kinetics, thermodynamics, processing aids, and fillers used during the compounding or mixing process are also tools of the trade that can impact the loading level and degree of enhancement resulting from incorporation. Blending processes such as melt blending, dry blending, and solution mixing blending are all effective at mixing and alloying nanoscopic silica agents into plastics.

Alternate Method: Solvent Assisted Formulation. Silicon containing agents can be added to a vessel containing the desired polymer, prepolymer or monomers and dissolved in a sufficient amount of an organic solvent (e.g. hexane, toluene, dichloromethane, etc.) or fluorinated solvent to effect the formation of one homogeneous phase. The mixture is then stirred under high shear at sufficient temperature to ensure adequate mixing for 30 minutes and the volatile solvent is then removed and recovered under vacuum or using a similar type of process including distillation. Note that supercritical fluids such as C0₂ can also be utilized as a replacement for the flammable hydrocarbon solvents. The resulting formulation may then be used directly or for subsequent processing.

### Example 1

### Permeability Barrier

The examples provided below shall not be construed as limiting toward specific material combinations or conditions.

Typical oxygen plasma treatments range from 1 second to 5 minutes under 100% power. Typical ozonolysis treatments range from 1 second to 5 minutes with ozone being administered through a CH₂Cl₂ solution with 0.03 equivalents O₃ per vinyl group. Typical steam treatments range from 1 second to 5 minutes. Typical oxidizing flame treatments range from 1 second to 5 minutes.

| | | % | Oxi- | *P | | *Perm |
|---|---|---|---|---|---|---|
| | | POSS | dation | W/O | *P W | after |
| Polymer | POSS | Loading | Method | POSS | POSS | oxidation |
| Nylon 6 | MS0825 | 1 | Plasma | 4-25 | 0.06 | |
| | | | | (O₂) | (O₂) | |
| | | | | 130 | 1.56 | |
| | | | | (H₂O) | (H₂O | |
| Nylon 6 | MS0830 | 1 | Plasma | 4-25 | 0.14 | |
| | | | | (O₂) | (O₂) | |
| | | | | 130 | 1.52 | |
| | | | | (H₂O) | (H₂O) | |
| Cellulose | SO1455 | | Plasma | 55 | 60 | |
| Prop | | | | (O₂) | (O₂) | |
| PP | MS0830 | | | | | |
| Adhesive | | | | | | |
| PET | SO1455 | | | | | |

*P (Permeability): cc m⁻² day⁻¹ atm⁻¹ (gm m⁻² day⁻¹ for H₂O)

### Example 2

### Packaged Food Improvements

The following represents advantages observed through the incorporation of this invention into food packaging.

| | Improved | Cost | Hot | Odor | Vitamin | Flavor | Improved | Chemical |
|---|---|---|---|---|---|---|---|---|
| | shelf life | Reduction | Strength | Control | Preservation | Scalpinq | printability | Resistance |
| Juice | Y | Y | Y | Y | Y | Y | Y | Y |
| Vegetables | Y | Y | Y | Y | Y | Y | Y | Y |
| Meats | Y | Y | Y | Y | Y | Y | Y | Y |
| Stand-up | Y | Y | Y | Y | Y | Y | Y | Y |
| pouches | | | | | | | | |

### Example 3

### Packaging Performance Based on Design

A series of silicon containing additives were incorporated into silicone and epoxy thermosets, polyolefin and polycarbonate thermoplastics and their absorption characteristics were measured relative to incident dosages of UV-Vis, neutron, gamma and low energy photons. The primary advantage for the low Z alloyed polymers was observed for low energy photons (<1000 ev). The improvement is attributed to an increase in electron density in the material which provides shielding against the damaging effects of the incident radiation. The primary advantage for the high Z alloyed polymers was blockage of the high energy UV radiation from damaging and discoloring silicon and polycarbonates. The improvement is attributed to extension of the UV absorption characteristics of the glass layer to the 90-390 nm range.

While certain representative embodiments and details have been shown for purposes of illustrating the invention, it will be apparent to those skilled in the art that various changes in the methods and apparatus disclosed herein may be made without departing from the scope of the invention which is defined in the appended claims.

What is claimed is:

1. A method for in situ formation of a glass layer on a polymer surface comprising the steps of:
(a) incorporating a nanoscopically dispersed silicon containing agent into a polymer; and
(b) oxidizing a surface of the polymer to form a glass layer.

2. A method according to claim 1, wherein a mix of different silicon containing agents is incorporated into the polymer.

3. A method according to claim 1, wherein the polymer is selected from the group consisting of polyethylenes, polypropylenes, polyamides, and adhesives.

4. A method according to claim 1, wherein the polymer is a polymer coil, a polymer domain, a polymer chain, a polymer segment, or mixtures thereof.

5. A method according to claim 1, wherein the silicon containing agent reinforces the polymer at a molecular level.

6. A method according to claim 1, wherein the incorporation is nonreactive.

7. A method according to claim 1, wherein the incorporation is reactive.

8. A method according to claim 1, wherein a physical property of the polymer is improved as a result of incorporating the silicon containing agent into the polymer.

9. A method according to claim 1, wherein a physical property of the polymer is improved as a result of in situ formation of the glass layer.

10. A method according to claim 8, wherein the physical property is selected from the group consisting of adhesion, water repellency, density, glass transition, viscosity, melt transition, storage modulus, relaxation, stress transfer, abrasion resistance, gas and moisture permeability, adhesion, biological compatibility, chemical resistance, porosity, radiation absorption, and optical quality.

11. A method according to claim 9, wherein the physical property is selected from the group consisting of adhesion, water repellency, density, glass transition, viscosity, melt transition, storage modulus, relaxation, stress transfer, abrasion resistance, gas and moisture permeability, adhesion, biological compatibility, chemical resistance, porosity, radiation absorption, and optical quality.

12. A method according to claim 8, wherein the incorporation step is accomplished in combination with at least one other filler or additive.

13. A method according to claim 9, wherein the incorporation step is accomplished in combination with at least one other filler or additive.

14. A method for improving barrier properties in multilaminate packaging comprising the steps of:
(a) incorporating a nanoscopically dispersed silicon containing agent into a polymer selected from the group consisting of polyethylenes, polypropylenes, and polyamides; and
(b) oxidizing a surface of the polymer to form a glass layer.

15. A method according to claim 1, wherein a mix of different silicon containing agents is incorporated into the polymer.

16. A method according to claim 14, wherein the polymer is a polymer coil, a polymer domain, a polymer chain, a polymer segment, or mixtures thereof.

17. A method according to claim 14, wherein the silicon containing agent reinforces the polymer at a molecular level.

18. A method according to claim 14, wherein the incorporation is nonreactive.

19. A method according to claim 14, wherein the incorporation is reactive.

20. A method according to claim 14, wherein a physical property of the polymer is improved as a result of incorporating the silicon containing agent into the polymer.

21. A method according to claim 14, wherein a physical property of the polymer is improved as a result of in situ formation of the glass layer.

22. A method according to claim 20, wherein the physical property is selected from the group consisting of adhesion, water repellency, density, glass transition, viscosity, melt transition, storage modulus, relaxation, stress transfer, abrasion resistance, gas and moisture permeability, adhesion, biological compatibility, chemical resistance, porosity, radiation absorption, and optical quality.

23. A method according to claim 21, wherein the physical property is selected from the group consisting of adhesion, water repellency, density, glass transition, viscosity, melt transition, storage modulus, relaxation, stress transfer, abrasion resistance, gas and moisture permeability, adhesion, biological compatibility, chemical resistance, porosity, radiation absorption, and optical quality.

24. A method according to claim 20, wherein the incorporation step is accomplished in combination with at least one other filler or additive.

25. A method according to claim 21, wherein the incorporation step is accomplished in combination with at least one other filler or additive.

26. The method of claim 14, wherein the silicon containing agent includes a metal.

27. The method of claim 28, wherein the metal slows the degradation of the polymer or the contents of the packaging.
